(19) United States
(12) Patent Application Publication
(10) Pub. No.: US 2025/0348979 A1
(43) Pub. Date: Nov. 13, 2025

(54) ELECTRONIC DEVICE, METHOD, AND NON-TRANSITORY COMPUTER READABLE STORAGE MEDIUM FOR RESTORING LOW-RESOLUTION IMAGE BY USING IMAGE RESTORATION MODEL WITH REDUCED SEMANTIC BIAS

(71) Applicant: THINKWARE CORPORATION, Seongnam-si (KR)

(72) Inventors: Dongwoo PARK, Seongnam-si (KR); Sukpil KO, Seongnam-si (KR)

(21) Appl. No.: 19/206,183

(22) Filed: May 13, 2025

(30) Foreign Application Priority Data
May 13, 2024 (KR) 10-2024-0062808

(51) Int. Cl. G06T 5/60; G06T 3/4046; G06V 10/44; G06V 10/774; G06V 10/776; G06V 10/82; G06V 20/62

(52) U.S. Cl. CPC G06T 5/60; G06T 3/4046; G06V 10/44; G06V 10/774; G06V 10/776; G06V 10/82; G06V 20/62; G06T 2207/20081; G06T 2207/20084

(57) ABSTRACT

According to an embodiment, an electronic device obtains an input image of a first resolution that includes one or more characters. The electronic device, using the input image, performs training of an image restoration model including a sub model trained to output a text probability map representing the one or more characters associated with the input image, an encoder configured to extract feature information from the input image, a fusion layer configured to combine the text probability map and the feature information, and a decoder connected to the fusion layer and for generating an output image with a second resolution higher than the first resolution. The sub model is trained through one or more masked attention scores obtained by applying a specified masking ratio for a different single character selected among the one or more characters.

### TECHNICAL FIELD

The present disclosure relates to an electronic device, a method, and a non-transitory computer-readable storage medium for restoring a low-resolution image by using an image restoration model with reduced semantic bias.

### BACKGROUND ART

Technology for processing a photo and/or a video using artificial intelligence is being developed. For example, technology for classifying a subject (e.g., an object including a person, an animal, and/or a vehicle) captured by the photo and/or the video is being developed. For example, technology for recognizing one or more characters (or character strings) related to the photo and/or the video is being developed.

The above-described information may be provided as a related art for the purpose of helping understanding of the present disclosure. No claim or determination is raised as to whether any of the above-described descriptions may be applied as the prior art related to the present disclosure.

### SUMMARY

### Technical Solution

According to an embodiment, an electronic device may comprise memory storing instructions. The electronic device may comprise at least one processor configured to execute the instructions. The instructions, when executed by the at least one processor individually or collectively, may cause the electronic device to obtain an input image of a first resolution that includes one or more characters. The instructions, when executed by the at least one processor individually or collectively, may cause the electronic device to, using the input image, perform training of an image restoration model including a sub model trained to output a text probability map representing the one or more characters associated with the input image, an encoder configured to extract feature information from the input image, a fusion layer configured to combine the text probability map and the feature information, and a decoder connected to the fusion layer and for generating an output image with a second resolution higher than the first resolution. The sub model may be trained through one or more masked attention scores obtained by applying a specified masking ratio for a different single character selected among the one or more characters.

According to an embodiment, a method of an electronic device may be provided. The method may comprise obtaining an input image of a first resolution that includes one or more characters. The method may comprise, using the input image, performing training of an image restoration model including a sub model trained to output a text probability map representing the one or more characters associated with the input image, an encoder configured to extract feature information from the input image, a fusion layer configured to combine the text probability map and the feature information, and a decoder connected to the fusion layer and for generating an output image with a second resolution higher than the first resolution. The sub model may be trained through one or more masked attention scores obtained by applying a specified masking ratio for a different single character selected among the one or more characters.

In an embodiment, a non-transitory computer readable storage medium comprising instructions may be provided. The instructions may be configured, when executed by at least one processor of an electronic device individually or collectively, to cause the electronic device to obtain an input image of a first resolution that includes one or more characters. The instructions may be configured, when executed by the at least one processor individually or collectively, to cause the electronic device to, using the input image, perform training of an image restoration model including a sub model trained to output a text probability map representing the one or more characters associated with the input image, an encoder configured to extract feature information from the input image, a fusion layer configured to combine the text probability map and the feature information, and a decoder connected to the fusion layer and for generating an output image with a second resolution higher than the first resolution. The sub model may be trained through one or more masked attention scores obtained by applying a specified masking ratio for a different single character selected among the one or more characters.

According to an embodiment, a method of an electronic device may be provided. The method may comprise receiving a request for restoring an input image of a first resolution to an output image of a second resolution exceeding the first resolution. The method may comprise, based on the received request, executing an image restoration model including an encoder configured to extract feature information from the input image, a sub model to determine a text probability map for the input image, a fusion layer configured to combine the text probability map and the feature information, and a decoder connected to the fusion layer and for generating the output image of the second resolution. The method may comprise providing the output image of the second resolution, obtained based on the execution of the image restoration model, as a response to the request. The sub model may be trained through one or more masked attention scores obtained by applying a specified masking ratio for a different single character selected among the one or more characters.

### BRIEF DESCRIPTION OF THE DRAWINGS

FIG. 1 illustrates an exemplary block diagram of an electronic device for restoring at least a portion of an image.

FIG. 2 illustrates an exemplary block diagram of an image restoration model executed by an electronic device according to an embodiment.

FIG. 3 illustrates an exemplary block diagram of a model for unbiased prior knowledge included in an image restoration model executed by an electronic device according to an embodiment.

FIG. 4 illustrates an exemplary block diagram of a model for key generation included in an image restoration model executed by an electronic device according to an embodiment.

FIG. 5 illustrates an exemplary block diagram of a structure of an image restoration model executed by an electronic device according to an embodiment.

FIG. 6 illustrates an exemplary block diagram of a teacher model connected to a model for prior knowledge information included in an image restoration model executed by an electronic device according to an embodiment.

FIGS. 7A and 7B illustrate at least one license plate (or number plate), which is a subject included in an image restored by an image restoration model according to an embodiment.

### DETAILED DESCRIPTION OF EXEMPLARY EMBODIMENTS

Hereinafter, various embodiments of the present document will be described with reference to the accompanying drawings.

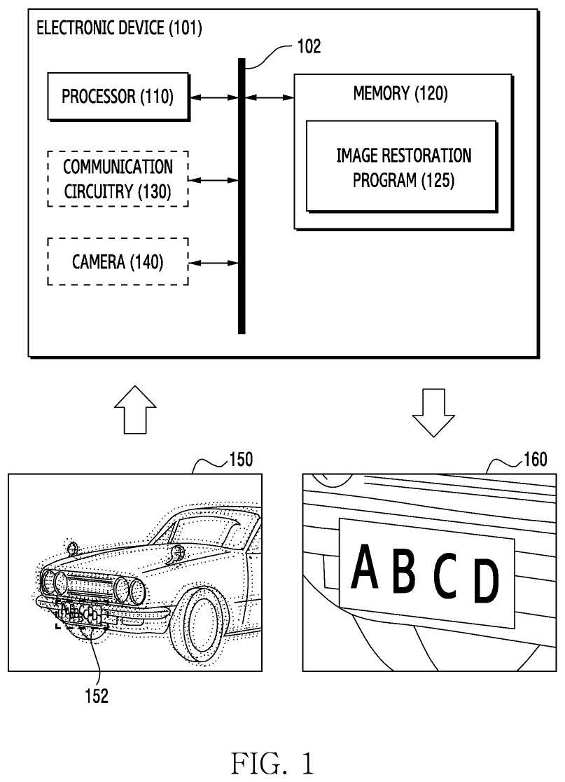

FIG. 1 illustrates an exemplary block diagram of an electronic device 101 to restore at least a portion of an image 150. The electronic device 101 may be configured to at least partially restore or enhance the image 150. Restoring or enhancing the image 150 may include an operation of improving visibility of a subject represented by the image 150 by compensating for distortion included in the image 150, such as blur, afterimage, and optical flow.

Referring to FIG. 1, the image 150 including a portion 152 associated with a license plate (or a number plate) is exemplarily illustrated. For example, the image 150 may be transmitted from an external electronic device to the electronic device 101 through communication circuitry 130. For example, the image 150 may be obtained using a camera 140 included in the electronic device 101. For example, the image 150 may be a file with a format based on a joint photographic experts group (jpeg). For example, the image 150 may include raw data obtained from the camera 140. For example, the image 150 may be included in a sequence (e.g., a video) of image frames, which is included in a video and set to be displayed sequentially. A means for obtaining or receiving the image 150 is not limited to the communication circuitry 130 and/or the camera 140 illustrated in FIG. 1.

Referring to the exemplary image 150 of FIG. 1, an exemplary subject such as a vehicle may be captured. The image 150 may be distorted according to an environment in which a subject is photographed. For example, in case that the subject is moving (e.g., driving of a vehicle), and/or a camera (e.g., the camera 140) controlled to obtain the image 150 is moving (or shaking), an appearance of the subject represented by pixels of the image 150 may be distorted. According to an embodiment, the electronic device 101 may enable the appearance of the subject represented by the image 150 to be clear, by at least partially reducing or removing the distortion generated in the image 150.

Referring to FIG. 1, an exemplary hardware configuration of the electronic device 101 to at least partially restore the image 150 is illustrated. For example, the electronic devices 101 may include a personal computer such as a laptop and a desktop, a smartphone, a smart pad, and a tablet PC. For example, the electronic device 101 may include a smart accessory such as a smartwatch, a smart ring, and/or a head-mounted device (HMD). For example, the electronic device 101 may be referred to as a mobile device, user equipment (UE), a multifunction device, a portable communication device, and/or a portable device. For example, the electronic device 101 may be included as an electronic control unit (ECU) in a vehicle (e.g., an electric vehicle (EV)). For example, the electronic device 101 may include a server of a service provider that provides a service for restoring the image 150. The server may include one or more PCs and/or workstations.

Referring to FIG. 1, according to an embodiment, the electronic device 101 may include at least one of a processor 110, memory 120, the communication circuitry 130, or the camera 140. According to an embodiment, the communication circuitry 130 and/or the camera 140 may not be included in the electronic device 101. For example, the communication circuitry 130 and/or the camera 140 may be disposed outside the electronic device 101 and may be electrically connected to the electronic device 101.

Referring to FIG. 1, the processor 110, the memory 120, the communication circuitry 130, and the camera 140 may be electronically and/or operably coupled with each other by an electronical component such as a communication bus 102. Hereinafter, electronical components being operably combined may mean that a direct connection or an indirect connection between first electronical components and second electronical components is established by wire or wirelessly so that a second electronical component is controlled by a first electronical component. Although illustrated based on different blocks, an embodiment is not limited thereto, and a portion of (e.g., at least a portion of the processor 110, the memory 120, and the communication circuitry 130) the electronical components of FIG. 1 may be included in a single integrated circuit such as a system on a chip (SoC). A type and/or the number of electronical components included in the electronic device 101 is not limited as illustrated in FIG. 1. For example, the electronic device 101 may include only a portion of the electronical components illustrated in FIG. 1.

The processor 110 of the electronic device 101 according to an embodiment may include circuitry (e.g., processing circuitry) for processing data based on one or more instructions. The circuitry for processing data may include, for example, an arithmetic and logic unit (ALU), a floating point unit (FPU), a field programmable gate array (FPGA), a central processing unit (CPU), a graphic processing unit (GPU), a neural processing unit (NPU), and/or an application processor (AP). For example, the number of the processors 110 may be one or more. The processing circuitry of the processor 110 that loads (or fetches) an instruction and performs a calculation corresponding to the loaded instruction may be referred to or referenced as core circuitry (or a core). For example, the processor 110 may have a structure of a multi-core processor including a plurality of core circuitries, such as a dual core, a quad core, a hexa core, or an octa core. A function and/or an operation described with reference to the present disclosure may be individually and/or collectively performed by one or more processing circuitries included in the processor 110.

According to an embodiment, the memory 120 of the electronic device 101 may include circuitry for storing data and/or an instruction inputted and/or outputted to the processor 110. The memory 120 may include, for example, volatile memory such as random-access memory (RAM) and/or non-volatile memory such as read-only memory (ROM). The non-volatile memory may be referred to as storage. The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive (SSD), and an embedded multi media card (eMMC). The memory 120 may include one or more storage mediums (e.g., the volatile memory and/or nonvolatile memory described above) positioned in the electronic device 101 in a distributed manner. The processor 110 of the electronic device 101 may perform a function and/or an operation indicated by instructions, by executing the instructions of the memory 120 in the electronic device 101. For example, in case that the electronic device 101 includes at least one processor, the at least one processor may be configured to execute the instructions collectively or individually.

According to an embodiment, the communication circuitry 130 of the electronic device 101 may include hardware for supporting transmission and/or reception of an electrical signal between the electronic device 101 and the external electronic device (e.g., a user terminal configured to transmit the image 150). The communication circuitry 130 may include at least one of, for example, a modem, an antenna, and an optic/electronic (O/E) converter. The communication circuitry 130 may support transmission and/or reception of an electrical signal based on various types of protocols, such as Ethernet, a local area network (LAN), a wide area network (WAN), wireless fidelity (WiFi), near field communication (NFC), Bluetooth, bluetooth low energy (BLE), ZigBee, long term evolution (LTE), fifth generation (5G), a new radio (NR), sixth generation (6G), and/or above-6G.

According to an embodiment, the camera 140 of the electronic device 101 may include one or more optical sensors (e.g., a charged coupled device (CCD) sensor and a complementary metal oxide semiconductor (CMOS) sensor) that generate an electrical signal indicating a color and/or brightness of light. The plurality of optical sensors included in the camera 140 may be disposed in a form of a 2 dimensional array. The camera 140 may generate 2 dimensional frame data corresponding to light reaching the optical sensors of the 2 dimensional array, by obtaining an electrical signal of each of the plurality of optical sensors substantially simultaneously. For example, photo data captured using the camera 140 may mean a 2 dimensional frame data obtained from the camera 140. For example, video data captured using the camera 140 may mean a sequence of a plurality of 2 dimensional frame data obtained from the camera 140.

Referring to FIG. 1, the processor 110 of the electronic device 101 according to an embodiment may at least partially restore or enhance the image 150 by executing an image restoration program 125. The processor 110 (e.g., the CPU, the GPU, and/or the NPU) executing the image restoration program 125 may perform calculations for restoring the image 150. The calculations may be associated with a calculation model (e.g., an artificial neural network, and/or a neural network) configured to simulate a neural activity of a living organism. The neural activity may include, for example, a cognitive activity, an inference activity, and/or a creative activity of a living organism. For example, instructions indicating the calculation model, formulas associated with the calculation model, and/or a constant (e.g., coefficients and/or weights) included in the formulas, may be at least partially included in the image restoration program 125.

According to an embodiment, the processor 110 of the electronic device 101 may restore or enhance the portion 152 (e.g., a portion of an object in which one or more characters are printed is captured, such as a number plate and/or a sign plate) in which at least one character is captured, in the image 150. For example, in the image 150, the electronic device 101 may extract or segment (or crop) the portion 152 associated with at least one character. The portion 152 may be referred to as a region of interest (ROI). The processor 110 may restore or enhance the portion 152 by executing the image restoration program 125.

In an embodiment, the electronic device 101 may increase or enhance a resolution of a scene by recognizing text (e.g., text that is indicated as being captured or included in the scene) associated with the scene such as the image 150. For example, in case of detecting one or more characters from a scene of a relatively low resolution (or small size), the electronic device 101 may generate another scene corresponding to the scene and having a higher resolution (or a larger size) than the resolution of the scene, by using a shape and/or an appearance of the detected one or more characters. For example, with respect to a scaling factor f, from a scene with a width w and a height h, the electronic device 101 may generate or output a scene with a width fw and a height fh.

In an embodiment, in terms of recognizing text and generating a high-resolution scene, the image restoration program 125 and/or artificial intelligence driven by the image restoration program 125 may be referred to as a scene text image super-resolution (STISR) and/or a model for the STISR. A performance of the STISR may be evaluated using accuracy (e.g., STISR accuracy) of a character included in the high-resolution scene generated by executing the STISR.

Referring to FIG. 1, an image 160 that the electronic device 101 outputs as a result of restoring the portion 152 of the image 150 is illustrated. The image 150 and/or the portion 152 may be referred to as an input image in terms of being inputted to the processor 110 of the electronic device 101. The image 160 may be referred to as an output image in terms of output data corresponding to the input image. According to an embodiment, the electronic device 101 may obtain information indicating one or more characters associated with the portion 152 by using an artificial intelligence model trained to recognize one or more characters from an image. By using the information, the electronic device 101 may generate or output the image 160 as a high-resolution image corresponding to the portion 152.

Referring to FIG. 1, the image 160 may have a larger size than the portion 152 and/or a higher resolution than the portion 152. Dimensions (e.g., a width and/or a height) of the image 160 may be greater than dimensions of the portion 152. For example, the image 160 may have the same dimensions and/or resolution as the image 150. In an embodiment of receiving the image 150 and/or the portion 152 from the external electronic device through the communication circuitry 130, the electronic device 101 may receive a request for restoring the portion 152 of the image 150 with a first resolution to the image 160 with a second resolution greater than the first resolution. From a signal received from the external electronic device, the electronic device 101 may identify or detect the image 150 and/or the portion 152. The signal may include a command and/or an operand indicating the request for restoration of the portion 152. In an embodiment of receiving the entire image 150 including the portion 152, the processor 110 of the electronic device 101 may extract or segment the portion 152 in which a subject relation to one or more characters is captured, such as a number plate. The portion 152 may be used as an image used for restoration.

Based on the request for restoring the image 150 and/or the portion 152, the electronic device 101 may execute an artificial intelligence model (e.g., an image restoration model) provided by the image restoration program 125. The electronic device 101 may provide the image 160 of the second resolution, obtained based on the execution of the image restoration model, as a response to the request. For example, the electronic device 101 may transmit a signal including the image 160 to the external electronic device through the communication circuitry 130.

In an embodiment, the image restoration model executed by the image restoration program 125 may include a sub model trained to recognize one or more characters (e.g., indicated to be captured by an input image) associated with the input image (e.g., the portion 152 and/or the image 150 including the portion 152) inputted to the image restoration model. The sub model, which is information (e.g., explicit information) readable by the processor 110 executing a software application distinct from the image restoration model and/or the image restoration program 125, may be trained to output information indicating the one or more characters associated with the input image, degrees to which each of the one or more characters is associated with the input image (e.g., probabilities that one or more characters are captured by the input image), and/or a positional relationship of the one or more characters (e.g., a position and/or an order of each of the one or more characters in a character string).

For example, the information outputted from the sub model may be referred to as text probability information in terms of including probabilities indicating text indicated to be captured by the input image. The text probability information may be referred to as text categorical information, text probability, a text probability map, text prior information, and/or text distribution. For example, the text probability information may include category information of text and/or information indicating a visual cue for text in an image.

According to an embodiment, the electronic device 101 may be trained to generate the image 160 using an intermediate state and/or intermediate information of the sub model trained to output explicit information such as the text probability information. For example, among nodes (e.g., perceptrons) of the sub model, which are distinguished by a plurality of layers, values of nodes that are different from nodes of an output layer including nodes corresponding to each element of the text probability information may be directly transmitted to another sub model of the image restoration model. For example, an intermediate layer of the sub model may be connected to the other sub model of the image restoration model.

For example, values of nodes included in the intermediate layer may be implicit information that is distinct from the explicit information. The implicit information may include more detailed information with respect to an input image than text probability information, which includes only probabilities that the input image (e.g., the portion 152 and/or the image 150) corresponds to each of a plurality of characters. By executing the image restoration model using the implicit information, the electronic device 101 may restore the portion 152 more accurately. For example, the electronic device 101 may obtain or generate the image 160 that more accurately represents one or more characters included in the portion 152. In the example, since more accurately recognizing or representing one or more characters from the portion 152, when receiving requests to repeatedly restore the portion 152, a plurality of images (e.g., the image 160) generated in response to the requests may include similar characters to each other.

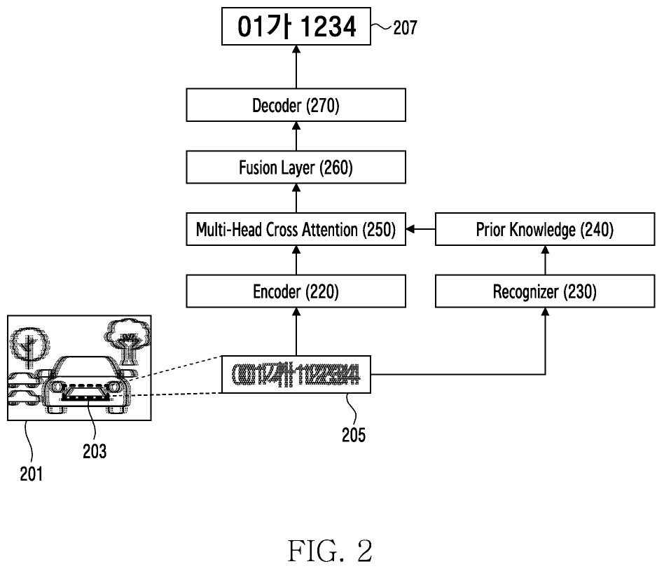

Hereinafter, an exemplary structure of the image restoration model executed by the image restoration program 125 and a process of training the image restoration model will be exemplarily described with reference to FIGS. 2 to 6.

FIG. 2 illustrates an exemplary block diagram of an image restoration model executed by an electronic device according to an embodiment.

The electronic device 101 and/or the processor 110 of FIG. 1 may execute the image restoration model described with reference to FIG. 2 by executing an image restoration program 125.

Hereinafter, an operation of executing an artificial intelligence model, such as the image restoration model, may include operations of performing one or more calculations associated with the artificial intelligence model by using a processor device (e.g., the processor 110 of FIG. 1 including the GPU and/or the NPU) of the electronic device. The operation of executing the artificial intelligence model may include an operation of inputting commands (or instructions) indicating the calculations to the GPU and/or the NPU to perform the calculations by the GPU and/or the NPU. The operation of executing the artificial intelligence model may include an operation of inputting data (e.g., an input image such as an entire image 201 and/or a partial (cropped) input image 205) to be at least partially changed by the calculations to the GPU and/or the NPU. Although the operation of executing the artificial intelligence model based on the GPU and/or the NPU has been exemplarily described, an embodiment is not limited thereto, and an operation of executing the artificial intelligence model using a CPU may also be performed similarly to the above-described operation.

Referring to FIG. 2, calculations performed by the image restoration model are illustrated as a plurality of blocks for distinguishing types and/or an order of the calculations. Any one block of FIG. 2 may correspond to a group of the calculations performed while executing the artificial intelligence model (e.g., the image restoration model). Each of the blocks of FIG. 2 may be referred to as an operation, layer(s), a sub model and/or a module for the artificial intelligence model. Referring to FIG. 2, the image restoration model including a (pre-trained) image encoder 210 is exemplarily illustrated to extract (or obtain) global context information.

In an embodiment, the image restoration model may include an encoder 220. In an embodiment, the encoder 220 may be an encoder for extracting (low level) feature information from the partial input image 205. In an embodiment, the encoder 220 may be a spatial transformer networks (STN) operation and a convolution operation. In an embodiment, the encoder 220 may include a shallow convolutional neural network (CNN) with less loss of structural information (or spatial information) required for image restoration. The shallow CNN may include fewer layers than a backbone network (e.g., ResNet including 50 or more convolutional layers) having a structure in which a large number of layers are connected in series for feature extraction. The backbone network may be trained to perform a high-level vision task of calculating a class vector from a high-resolution image, such as a classification task. The encoder (or STISR) of the image restoration model may include a relatively small number of layers to reduce loss of structural information (or spatial information) of a low-resolution image when extracting features of the low-resolution image to perform a low-level vision task (e.g., increasing a resolution of the image). In an embodiment, by executing the encoder 220, the electronic device 101 may generate (or obtain) feature information on the partial input image 205. In an embodiment, the feature information on the partial input image 205 may be referred to as local information obtained as a result of a crop algorithm for extracting a portion 203 of the entire image 201 based on a region of interest (RoI) obtained as a result of an algorithm for finding the region of interest, such as object detection or object segmentation. Feature information on the partial input image 205 obtained by inputting the partial input image 205 to the encoder 220 may be referred to as non-textual information (e.g., structural feature information). The feature information on the partial input image 205 obtained from the encoder 220 may be referred to as low-level feature information. As for the feature information, spatial information (e.g., a width, and a height) for utilizing the structural features of the partial input image 205 may be maintained. The feature information may be obtained through mapping to a channel having a higher dimension than a dimension of the partial input image 205.

In an embodiment, the encoder 220 may cause the electronic device 101 executing the image restoration model to generate an output image 207 using the non-textual information inferred from the partial input image 205.

For example, the image restoration model may include a recognizer 230 for determining a text probability map for the partial input image 205. An output layer of the recognizer 230 may include values determined by calculations performed for a linearization operation. The values included in the output layer may be text probability information. In an embodiment, the recognizer 230 may be trained to recognize one or more characters from a scene such as the partial input image 205. The recognizer 230 may be referred to as a scene-text recognizer (STR) and/or a STR model in terms of recognizing characters. The recognizer 230 may be referred to as a debiased STR (DSTR) and/or a DSTR model in terms of recognizing the characters in a state in which bias with respect to a semantic association between characters is reduced. Herein, the bias with respect to the semantic association between the characters being reduced may include a probability that a prediction of a character at a specific position relies on a positional relationship and/or a semantic relationship between the characters being reduced. The recognizer 230 may be configured to recognize or process features such as a shape and/or a position of the one or more characters in the partial input image 205. In an embodiment, the recognizer 230 may be a character recognizer that outputs a probability distribution or an implicit text embedding. Herein, the implicit text embedding may refer to embedding text through a hidden state of a decoder to prevent performance reduction due to misclassification of categorical information that a text probability distribution has.

Referring to FIG. 2, the output layer of the recognizer 230 may be associated with the linearization operation. Within the recognizer 230, (implicit) information that includes a result of performing a decoding prediction operation (or a state of any one intermediate layer for the decoding prediction operation), and is to be used for the linearization operation, may be provided to a multi head cross attention model 250. Information outputted by the recognizer 230 (e.g., information transmitted to the multi head cross attention model 250) may be referred to as prior knowledge information 240. The information on the partial input image 205 obtained from the recognizer 230 may be referred to as textual information.

In an embodiment, the recognizer 230 may cause the electronic device 101 executing the image restoration model to generate the output image 207 using the textual information (e.g., text probability information) inferred from the partial input image 205.

In an embodiment, the multi head cross attention model 250 may cause the electronic device 101 executing the image restoration model to generate the output image 207 using the prior knowledge information 240 (or the textual information) and the low-level feature information (or the non-textual information) inferred from the partial input image 205 from the entire image 201. In terms of using the prior knowledge information 240 and the low-level feature information, the image restoration model may be a model that supports multimodal.

In an embodiment, the multi head cross attention model 250 may cause the electronic device 101 executing the image restoration model to perform multi head cross attention using the prior knowledge information 240 and the low-level feature information. For example, the electronic device 101 executing the image restoration model may perform the multi head cross attention by using one (e.g., the low-level feature information) of the low-level feature information or the prior knowledge information 240 as a query and using the other (e.g., the prior knowledge information 240) as a key and a value.

Referring to FIG. 2, a fusion layer 260 may be configured to combine operation results of the multi head cross attention model 250. In the fusion layer 260, it may be configured to be combined with implicit information and the feature information of an intermediate layer of the sub model, positioned prior to the output layer trained to output the text probability map. For example, the electronic device 101 may perform calculations indicated by the fusion layer 260 using feature information including a result of performing the convolution operation of the encoder 220, and all of the text probability maps outputted or generated from the recognizer 230.

Referring to FIG. 2, the image restoration model may perform a decoder operation 270 to generate the output image 207 with a resolution higher than that of the partial input image 205, using information generated by the fusion layer 260. The decoder operation 270 may be trained to generate the output image 207 that has a resolution greater than the partial input image 205 and/or a size wider than the partial input image 205, and is associated with the partial input image 205 (e.g., including content of the partial input image 205), using the information generated by the fusion layer 260. The output image 207 may be provided as a result of restoring or enhancing the partial input image 205.

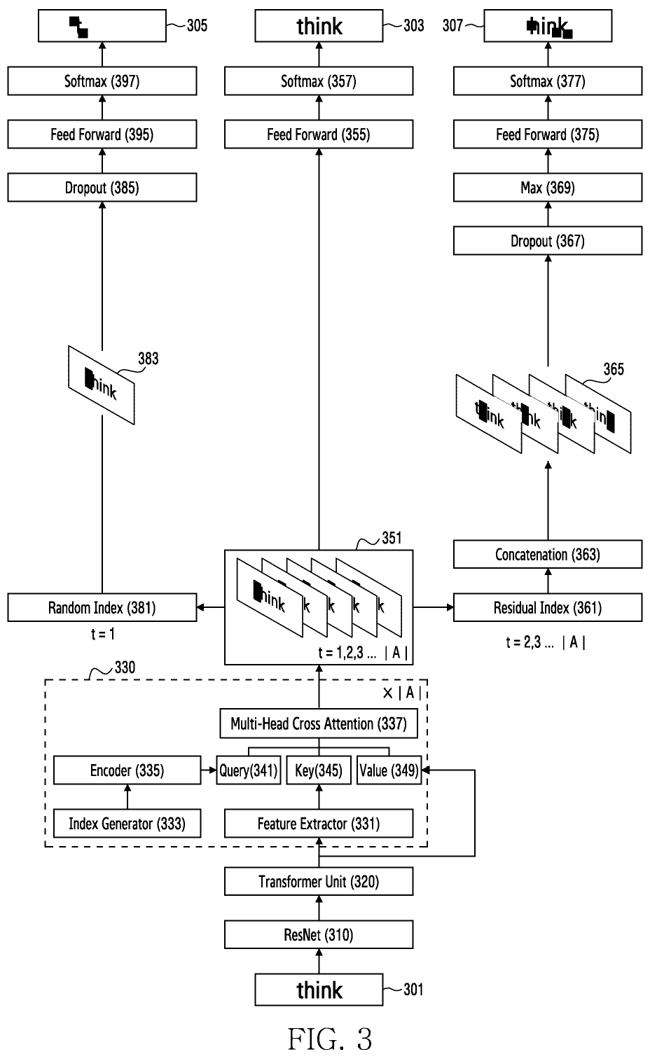

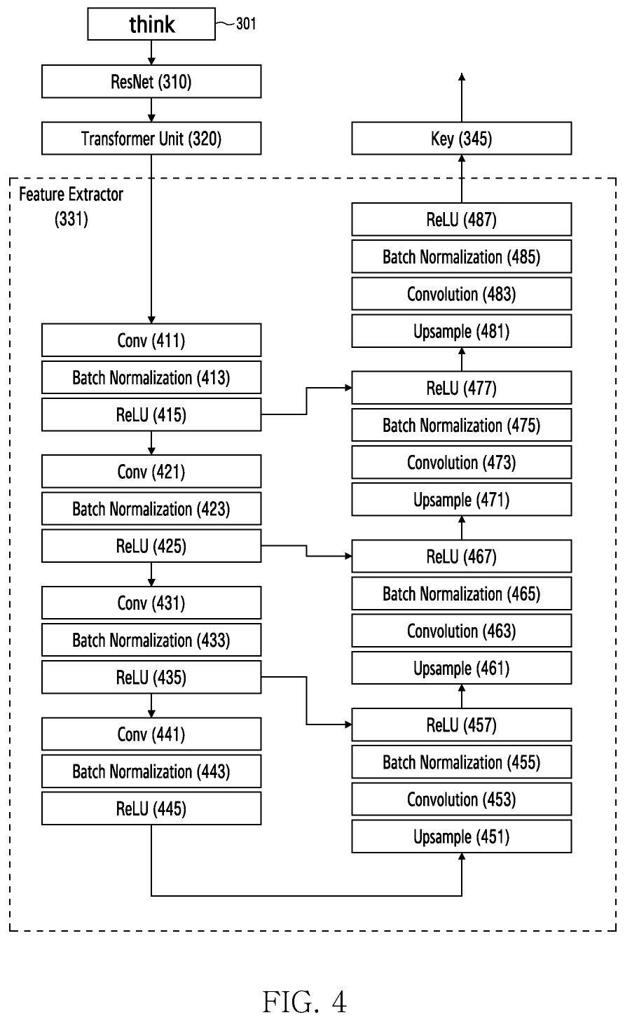

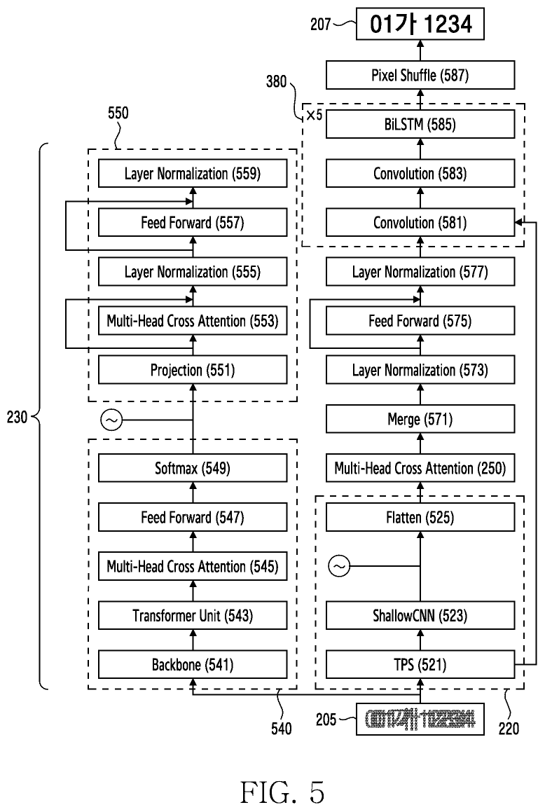

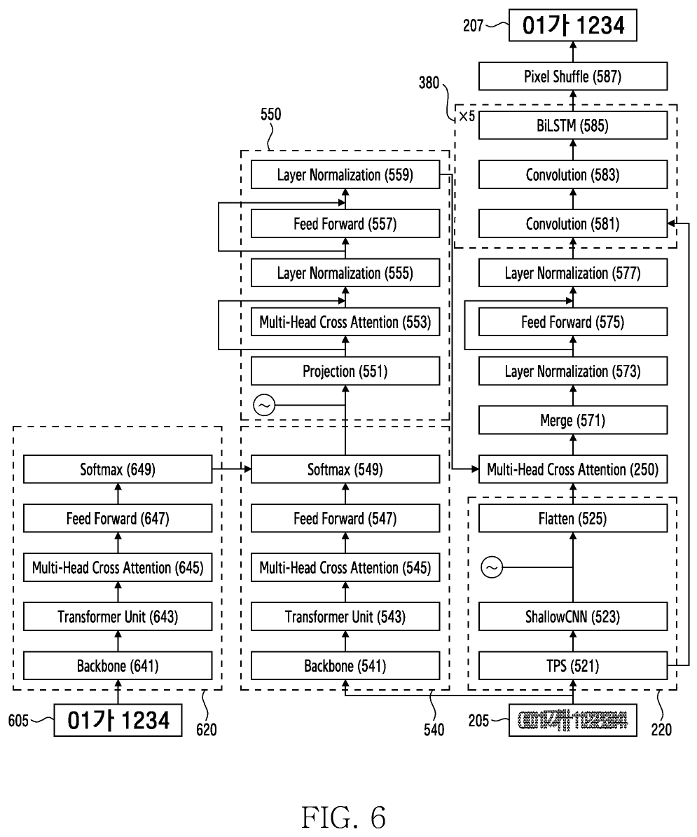

For example, the image restoration model may be trained to output the output image 207 as a result of enhancing the partial input image 205 by a first step of retraining (pre-trained) a partial model (e.g., a sub model 540 of FIG. 5 or FIG. 6) of the recognizer 230 and a second step of training the image restoration model including the retrained partial model. The first step of the training process is described with reference to FIGS. 3 and 4. The second step of the training process is described with reference to FIGS. 5 and 6.

FIG. 3 illustrates an exemplary block diagram of a model for unbiased prior knowledge included in an image restoration model executed by an electronic device according to an embodiment. The electronic device 101 and/or the processor 110 of FIG. 1 may train the image restoration model described with reference to FIG. 3 by executing an image restoration program 125.

According to an embodiment, based on receiving an image 301, the electronic device 101 may obtain a sub model 540 trained to output a text probability map representing one or more characters associated with the image. The electronic device may perform training again (e.g., fine-tuning) on the obtained sub model 540 using a loss function. The loss function may be set or defined to generate not only explicit information (e.g., text probability information) outputted from the sub model 540, but also implicit information representing a discriminative feature to be used by the image restoration model including the sub model 540.

In an embodiment, the image restoration model may extract a visual feature of the image 301 through an encoder. The encoder for extracting the visual feature of the image 301 may include a structure in which a ResNet 310 and a transformer unit 320 are sequentially connected. According to an embodiment, a connection order between the ResNet 310 and the transformer unit 320 of the encoder may be changed. For example, the image 301 may be sequentially operated through the transformer unit 320 and the ResNet 310. However, it is not limited thereto. The encoder may include a backbone network with various structures.

In an embodiment, the image restoration model may extract the visual feature of the image 301 through Equation 1 below.

$${F}_{v} = encoder ( img ) \qquad [ Equation 1 ]$$

In Equation 1, the Fᵥ may represent the visual feature (or feature information) of the image 301. In Equation 1, an encoder operation may be an operation for extracting the visual feature (or the feature information) of the img (or the image 301).

In an embodiment, an attention block 330 of the image restoration model may generate a query 341, a key 345, and a value 349 to calculate an attention score for the extracted visual feature. In an embodiment, the query 341 may have a size corresponding to the maximum number (e.g., 25) of all character strings included in the image 301. However, it is not limited thereto. According to a feature of an image processed by the image restoration model, a size of the query may be variously defined.

In an embodiment, an index generator 333 included in the attention block 330 of the image restoration model may generate an order of each of the one or more characters included in a character string included in the image 301. In an embodiment, an encoder 335 included in the attention block 330 of the image restoration model may generate the query 341 by embedding the order of each of the one or more characters included in the character string. For example, based on Equation 2 below, the encoder 335 may generate the query

$${Q}_{e}^{j}$$

341 by embedding the order j of each of the one or more characters included in the character string into a vector of a specified size. Herein, the j may be a natural number.

$${Q}_{e}^{j} = n n . embedding ( j ) \qquad [ Equation 2 ]$$

In an embodiment, a feature extractor 331 included in the attention block 330 of the image restoration model may obtain the key 345 from the visual feature of the image 301. The feature extractor 331 may have a structure of a (mini) U-net described below with reference to FIG. 4. However, it is not thereto. The feature extractor 331 may include various networks capable of mapping the visual feature to a high-dimensional vector.

The feature extractor 331 may obtain the key Kᵥ 345 from the visual feature Fy of the image 301 through Equation 3 below.

$${K}_{v} = FE ( {F}_{v} ) \qquad [ Equation 3 ]$$

In an embodiment, the attention block 330 of the image restoration model may obtain an attention score through an operation block 337 for an operation between the query 341 and the key 345. For example, in the operation block 337, a matrix multiplication operation and a softmax operation may be performed in series. The operation block 337 may obtain a j-th attention score

$${attn}_{v}^{j}$$

through Equation 4 below.

$${attn}_{v}^{j} = Softmax ( \frac{{Q}_{e}^{j} \cdot {K}_{v}^{T}}{\sqrt{{d}^{′}}} ) \qquad [ Equation 4 ]$$

The d of Equation 4 may represent a dimension of a key vector. The

$${Q}_{e}^{j}$$

of Equation 4, which is a result of embedding the order j of each of the one or more characters included in the character string of Equation 2 into a vector having a specified size, may represent a query vector. The Kᵥ, which is the visual feature Fᵥ of the image 301 of Equation 3, may represent a key vector,

$${Q}_{e}^{j} \cdot {K}_{v}^{T}$$

operation of Equation 4 may represent an attention score of self-attention. The T operation of Equation 4 may represent a matrix transpose operation.

In an embodiment, the attention block 330 of the image restoration model may obtain attention scores 351 as many as the number |A| (e.g., 5) of the characters in the character string (e.g., “think”) included in the image 301.

In an embodiment, the image restoration model may obtain a character string probability value 303 through a feed forward layer 355 and a softmax operation 357 for the attention scores 351 using Equation 5 below.

$$p = Softmax ( ( {attn}_{v} \cdot {F}_{v} ) \cdot {W}_{p} ) \qquad [ Equation 5 ]$$

In Equation 5, the attnᵥ may represent an attention score. In Equation 5, the Fᵥ may represent the visual feature (or the feature information) of the image 301. In Equation 5, the Wₚ, which is an fc layer (or weights of the fc layer), may represent a layer defined for a projection operation and an operation of the layer.

In an embodiment, the image restoration model may separate an attention score corresponding to a randomly selected index among indices representing the characters and remaining attention scores corresponding to remaining indices that are not selected. Herein, the index may represent the order j of the character.

In an embodiment, the image restoration model may separate attention scores 351 as many as the number (e.g., 5) of the characters into attention scores 383 corresponding to a randomly selected index 381 and attention scores corresponding to remaining indices 361. For example, among the characters in the character string (e.g., “think”) included in the image 301, the image restoration model may separate the attention score 383 corresponding to a character (e.g., ‘t’) according to the randomly selected index (e.g., t=1), and the attention scores corresponding to remaining characters (e.g., “think”) according to the remaining indices 361. According to an embodiment, the number of the randomly selected attention score from among the attention scores 351 may exceed 1.

In an embodiment, the image restoration model may select a ratio mask of a dropout mask with respect to each of the characters of the character string (e.g., “think”) included in the image 301. A ratio mask^{j}=torch.randn(j) of a dropout mask with respect to the j-th character of the character string (e.g., “think”) may have a value between 0 and 1. In an embodiment, the image restoration model may obtain a value 1−mask^{j} obtained by subtracting the ratio mask^{j} of the dropout mask from 1 as a semantic reliance score (SRS).

In an embodiment, the image restoration model may sequentially perform a dropout operation 385, a feed forward operation 395, and a softmax operation 397 with respect to the selected attention score 383. In an embodiment, the image restoration model may perform the dropout operation 385 with respect to the selected attention score through a ratio of a dropout mask with respect to the attention score 383 corresponding to the randomly selected index 381. In an embodiment, the image restoration model may obtain a character string probability value p_{rand} 305 by performing the feed forward operation 395 and the softmax operation 397 with respect to the attention score 383 that is dropped out. The image restoration model may obtain the character string probability value p_{rand} 305 based on the ratio mask^{j} of the dropout mask through Equation 6 below.

$$[ Equation 6 ]$$

$${p}_{rand} = Softmax ( ( nn . Dropout ( {F}_{rand} , p = 1 - {SRS}_{rand} ) \cdot {F}_{v} ) \cdot {W}_{p} )$$

In Equation 6, the F_{rand} may be the attention score 383 corresponding to the selected index 381. In Equation 6, the 1−SRS_{rand} may be the ratio mask^{j} of the dropout mask corresponding to the selected index 381. In Equation 6, the nn.Dropout(F_{rand}, p=1−SRS_{rand}) may represent a dropout operation on the attention score 383 based on the ratio mask^{j} of the dropout mask. In Equation 6, the Fᵥ may represent the visual feature of the image 301 according to Equation 1. In Equation 6, the Wₚ, which is the fc layer (or the weights of the fc layer), may represent the layer defined for the projection operation and the operation of the layer.

In an embodiment, the image restoration model may concatenate (e.g., torch.cat) 363 the remaining attention scores corresponding to the remaining indices to a specified channel axis. Herein, the specified channel axis may be one of dimensions of the remaining attention scores. The number of the dimensions of the remaining attention scores concatenated by the concatenation may be maintained without being increased. However, it is not limited thereto.

In an embodiment, the image restoration model may operate or obtain feature information concatenating the remaining attention scores to the specified channel axis through Equation 7 below.

$${F}_{res}^{′} = torch . cat ( {F}_{res} ) \qquad [ Equation 7 ]$$

In Equation 7, the Fᵣₑₛ may be the attention scores corresponding to the remaining index 361. In Equation 7, the

$${F}_{res}^{′}$$

may be an attention score 365 in which the attention scores corresponding to the remaining index 361 are concatenated by a specified axis. The

$${F}_{res}^{′}$$

may correspond to appending the attention scores for each channel.

In an embodiment, the image restoration model may sequentially perform a dropout operation 367, a maximum value selection operation 369, a feed forward operation 375, and a softmax operation 377 with respect to the concatenated attention score 365.

In an embodiment, the image restoration model may perform a dropout operation 367 with respect to the concatenated attention score 365 through the ratio of the dropout mask with respect to the concatenated attention score 365. In an embodiment, the image restoration model may perform a matrix multiplication operation 397 between the dropped-out attention score 383 and the visual feature Fᵥ. In an embodiment, the image restoration model may obtain the character string probability value p_{rand} 305 through the softmax operation 397 on the matrix-multiplied feature F_{rand}·Fᵥ.

In an embodiment, the image restoration model may select 369 the maximum value of a specified number (e.g., K) for each channel of the feature information Fᵣₑₛ through Equation 8.

$${F}_{res}^{″} = \{ ( m , n ) : {F}_{res}^{′} ∈ TopK ( {F}_{res}^{′} ) \} \qquad [ Equation 8 ]$$

In Equation 8, the

$${F}_{res}^{″}$$

may represent feature information configures with the maximum value of the specified number (e.g., K=500) for each channel. In Equation 8, m and n may represent positions of a width and a height of the image, respectively. For example, in case that m=1 and n=2, the (m, n):

$${F}_{res}^{′}$$

may refer to the (1,2)th pixel of the

$${F}_{res}^{′} .$$

In Equation 8, the TopK operation may be an operation of changing pixels other than pixels having the highest attention score of the specified number for each channel (time step) to a specified value (e.g., 0). In Equation 8, the TopK operation may be an operation for selecting attention scores having the highest value of the specified number for each channel (time step).

In an embodiment, the image restoration model may obtain the feature information

$${F}_{res}^{″}$$

configured with the maximum value of the specified number for each channel through the feed forward layer 375 and the softmax operation 377. In an embodiment, the image restoration model may obtain a character string probability value pᵣₑₛ 307 with respect to the feature information

$${F}_{res}^{″}$$

configured with the maximum value of the specified number for each channel through Equation 9 below.

$${p}_{res} = Softmax ( ( ( nn \cdot Dropout ( {F}_{res}^{″} , p = 1 - {SRS}_{res} ) ) \cdot {F}_{v} ) \cdot {W}_{p} ) \qquad [ Equation 9 ]$$

In Equation 9, the 1−SRSᵣₑₛ may be a ratio mask^{j} of a dropout mask corresponding to the remaining index 361. In Equation 9, the

$$nn \cdot Dropout ( {F}_{res}^{″} , p = 1 - {SRS}_{res} )$$

may represent a dropout operation based on a ratio mask^{j} of a dropout mask of the feature information

$${F}_{res}^{″} .$$

In Equation 9, the Fᵥ may represent the visual feature of the image 301 according to Equation 1. In Equation 9, the Wₚ, which is the fc layer (or the weights of the fc layer), may represent the layer defined for the projection operation and the operation of the layer.

In an embodiment, the image restoration model may obtain losses through each of the character string probability values p, p_{rand}, and pᵣₑₛ. In an embodiment, the image restoration model may obtain losses between a ground truth value gₜ and the character string probability values p, p_{rand}, and pᵣₑₛ through loss functions.

For example, the image restoration model may operate a loss associated with a randomly selected index (or a character) (or an attention score) through Equation 10 below. For example, the image restoration model may operate a loss associated with the character string probability value p_{rand} when K character strings among the character strings are randomly selected through Equation 10 below.

$${ℒ}_{rand} = - \frac{1}{K} {\sum }_{t = 0}^{K} {SRS}_{rand}^{t} \cdot log ( {p}_{rand}^{{}_{{}_{t}}} \vert {g}_{t} ) \qquad [ Equation 10 ]$$

Referring to Equation 10, the K may be the number of the randomly selected index. Referring to Equation 10, the

$$S R {S}_{rand}^{t}$$

may be a reliance score of the randomly selected index. Referring to Equation 10, the loss [symbol] _{rand} associated with the randomly selected index may be a cross entropy loss between the ground truth value gₜ and the character string probability value p_{rand} associated with the randomly selected index.

For example, the image restoration model may operate a loss associated with the remaining indices (or the remaining characters) (or the remaining attention scores) through Equation 11 below. For example, the image restoration model may operate a loss associated with the character string probability value pᵣₑₛ of the remaining character strings except for the K character strings randomly selected from the character strings through Equation 11 below.

$${ℒ}_{res} = - \frac{1}{N - K} {\sum }_{t = 0}^{N - K} S R {S}_{res}^{t} \cdot log ( {p}_{res}^{t} \vert {g}_{t} ) \qquad [ Equation 11 ]$$

Referring to Equation 11, the N may be the number of entire indices. Referring to Equation 11, the K may be the number of the randomly selected index. Referring to Equation 11, the NK may be the number of indices excluding the randomly selected index from the indices. Referring to Equation 11, the

$$SR {S}_{res}^{t}$$

may be a reliance score of the remaining indices. Referring to Equation 11, the loss [symbol] ᵣₑₛ associated with the remaining indices may be a cross entropy loss between the ground truth value gₜ and the character string probability value pᵣₑₛ associated with the remaining indices.

For example, the image restoration model may operate a loss associated with the entire indices (or the entire characters) (or the entire attention scores) through Equation 12 below. For example, the image restoration model may operate a loss associated with a character string probability value pₜ of the entire character strings through Equation 12 below. Herein, the character string probability value pₜ of Equation 12 may be a probability value based on an attention score to which a dropout mask is not applied. For example, the character string probability value pₜ of Equation 12 may be a probability value operated by Equation 5.

$${ℒ}_{l o g i t s} = - \frac{1}{N} {\sum }_{t = 0}^{N} log ( {p}_{t} \vert {g}_{t} ) \qquad [ Equation 12 ]$$

Referring to Equation 12, the loss [symbol] _{logits} associated with the entire indices may be a cross entropy loss between the ground truth value gₜ and the string probability value pₜ associated with the entire indices. Referring to Equation 12, the loss [symbol] _{logits} associated with the entire indices may not be multiplied by the reliance score as the dropout mask is not applied to the attention score.

In an embodiment, the image restoration model may operate the final loss by summing the losses. For example, the image restoration model may operate the final loss [symbol] _{balanced} through Equation 13 below.

$${ℒ}_{balanced} = α \cdot {ℒ}_{rand} \cdot β \cdot {ℒ}_{res} + γ \cdot {ℒ}_{logits} \qquad [ Equation 13 ]$$

In Equation 13, the α, the β, and the γ may be set to numerical values such as 0.5, 0.5, and 1, respectively. The [symbol] _{rand} of Equation 13 may be determined as in Equation 10. The [symbol] ᵣₑₛ of Equation 13 may be defined as Equation 11. The [symbol] _{logits} of Equation 13 may be defined as Equation 12.

According to an embodiment, the electronic device 101 may train the sub model 540 based on the final loss [symbol] _{balanced}. For example, the electronic device 101 may update parameters of the sub model 540 to reduce the final loss [symbol] _{balanced}.

FIG. 4 illustrates an exemplary block diagram of a model for key generation included in an image restoration model executed by an electronic device according to an embodiment. The electronic device 101 and/or the processor 110 of FIG. 1 may execute or train the image restoration model described with reference to FIG. 4 by executing an image restoration program 125. FIG. 4 may illustrate a structure of a (mini) U-net of a feature extractor 331 in detail.

Referring to FIG. 4, the feature extractor 331 may include a serial combination of a convolution operation 411, a batch normalization (BN) operation 413, and a rectified linear unit (ReLU) operation 415. In an embodiment, an output of a ResNet 310 (or an output of a transformer unit 320) may be processed through the serial combination of the convolution operation 411, the BN operation 413, and the ReLU operation 415. In an embodiment, the convolution operation may be an operation for performing a convolution operation between a kernel (or a filter) and an input image. In an embodiment, the BN operation may be an operation for normalizing the input image. In an embodiment, the ReLU operation may be an operation outputting values less than or equal to a reference value as a specified value (e.g., 0), by comparing each value of the input image with the reference value (e.g., 0).

In an embodiment, an output of the ReLU operation 415 may be inputted to the convolution operation 421 and the ReLU operation 477. Through the serial combination of the convolution operation 411, the BN operation 413, and the ReLU operation 415, a size of an output of an operation block including the convolution operation 411, the BN operation 413, and the ReLU operation 415 may be reduced than a size of the output of the ResNet 310. In an embodiment, a size of the output of the ReLU operation 415 may correspond to a size of an input of the ReLU operation 477.

Referring to FIG. 4, the feature extractor 331 may include a serial combination of a convolution operation 421, a BN operation 423, and a ReLU operation 425. The output of the ReLU operation 415 may be processed through the serial combination of the convolution operation 421, the BN operation 423, and the ReLU operation 425. In an embodiment, an output of the ReLU operation 425 may be inputted to a convolution operation 431 and a ReLU operation 467. Through the serial combination of the convolution operation 421, the BN operation 423, and the ReLU operation 425, a size of an output of an operation block including the convolution operation 421, the BN operation 423, and the ReLU operation 425 may be reduced than the size of the output of the ReLU operation 415. In an embodiment, a size of the output of the ReLU operation 425 may correspond to a size of an input of the ReLU operation 467.

Referring to FIG. 4, the feature extractor 331 may include a serial combination of the convolution operation 431, a BN operation 433, and a ReLU operation 435. The output of the ReLU operation 425 may be processed through the serial combination of the convolution operation 431, the BN operation 433, and the ReLU operation 435. In an embodiment, an output of the ReLU operation 435 may be inputted to a convolution operation 441 and a ReLU operation 457. Through the serial combination of the convolution operation 431, the BN operation 433, and the ReLU operation 435, a size of an output of an operation block including the convolution operation 431, the BN operation 433, and the ReLU operation 435 may be reduced than a size of the output of the ReLU operation 425. In an embodiment, a size of the output of the ReLU operation 435 may correspond to a size of an input of the ReLU operation 457.

Referring to FIG. 4, the feature extractor 331 may include a serial combination of the convolution operation 441, a BN operation 443, and a ReLU operation 445. The output of the ReLU operation 435 may be processed through the serial combination of the convolution operation 441, the BN operation 443, and the ReLU operation 445. In an embodiment, an output of the ReLU operation 445 may be inputted to an upsample operation 451. Through the serial combination of the convolution operation 441, the BN operation 443, and the ReLU operation 445, a size of an output of an operation block including the convolution operation 441, the BN operation 443, and the ReLU operation 445 may be reduced than the size of the output of the ReLU operation 435.

Referring to FIG. 4, the feature extractor 331 may include a serial combination of the upsample operation 451, a convolution operation 453, a BN operation 455, and the ReLU operation 457. The output of the ReLU operation 445 may be processed through the serial combination of the upsample operation 451, the convolution operation 453, the BN operation 455, and the ReLU operation 457. In an embodiment, the upsample operation may be an operation of enlarging a size of the input image by a specified ratio. In an embodiment, an output of ReLU operation 457 may be inputted to an upsample operation 461. Through the serial combination of the upsample operation 451, the convolution operation 453, the BN operation 455, and the ReLU operation 457, a size of an output of an operation block including the upsample operation 451, the convolution operation 453, the BN operation 455, and the ReLU operation 457, may be increased than a size of the output of the ReLU operation 445.

Referring to FIG. 4, the feature extractor 331 may include a serial combination of the upsample operation 461, a convolution operation 463, a BN operation 465, and the ReLU operation 467. An output of the ReLU operation 457 may be processed through the serial combination of the upsample operation 461, the convolution operation 463, the BN operation 465, and the ReLU operation 467. In an embodiment, an output of the ReLU operation 467 may be inputted to an upsample operation 471. Through the serial combination of the upsample operation 461, the convolution operation 463, the BN operation 465, and the ReLU operation 467, a size of an output of an operation block including the upsample operation 461, the convolution operation 463, the BN operation 465, and the ReLU operation 467, may be increased than a size of the output of the ReLU operation 457.

Referring to FIG. 4, the feature extractor 331 may include a serial combination of the upsample operation 471, a convolution operation 473, a BN operation 475, and the ReLU operation 477. The output of the ReLU operation 467 may be processed through the serial combination of the upsample operation 471, the convolution operation 473, the BN operation 475, and the ReLU operation 477. In an embodiment, an output of the ReLU operation 477 may be inputted to an upsample operation 481. Through the serial combination of the upsample operation 471, the convolution operation 473, the BN operation 475, and the ReLU operation 477, a size of an output of an operation block including the upsample operation 471, the convolution operation 473, the BN operation 475, and the ReLU operation 477, may be increased than a size of the output of the ReLU operation 467.

Referring to FIG. 4, the feature extractor 331 may include a serial combination of the upsample operation 481, a convolution operation 483, a BN operation 485, and a ReLU operation 487. The output of the ReLU operation 477 may be processed through the serial combination of the upsample operation 481, the convolution operation 483, the BN operation 485, and the ReLU operation 487. Through the serial combination of the upsample operation 481, the convolution operation 483, the BN operation 485, and the ReLU operation 487, a size of an output of an operation block including the upsample operation 481, the convolution operation 483, the BN operation 485, and the ReLU operation 487, may be increased than a size of the output of the ReLU operation 477. In an embodiment, an output of the ReLU operation 487 may be referred to as a key 345.

FIG. 5 illustrates an exemplary block diagram of a structure of an image restoration model executed by an electronic device according to an embodiment. The electronic device 101 and/or the processor 110 of FIG. 1 may execute or train the image restoration model described with reference to FIG. 5 by executing an image restoration program 125.

Referring to FIG. 5, the image restoration model may include a TPS model 521 and a shallow CNN 523. From a partial input image 205, the electronic device may extract low-level feature information by performing calculations represented by the TPS model 521 and the shallow CNN 523. The electronic device may obtain feature information of [symbol] ^{c×hw} by combining the feature information with position embedding data for a synthesis operation. The C of the [symbol] ^{c×hw} which is a number representing a dimension of the feature information, may correspond to the number of a dimension (a feature dimension generated as a RGB channel of an input image passes through the shallow CNN 323) of information outputted from an output layer of the shallow CNN 323. The hw of the [symbol] ^{c×hw} may represent a size (e.g., the number of parameters arranged in one dimension) of information (e.g., one dimensional information) flattening information (e.g., a height and a width of the image) of the partial input image 205.

By performing the calculations represented by the TPS model 521, the electronic device may adjust shapes of characters in the partial input image 205 so that the characters have uniform shapes. For example, information outputted from a Flatten model 525 connected to the shallow CNN 523 may correspond to Fᵥ of Equation 14.

$${F}_{v} = Flatten ( {Enc}_{1} ( TPS ( {x}_{LR} ) ) + P E ) \qquad [ Equation 14 ]$$

The x_{LR} of Equation 14 may represent the partial input image 205 having a relatively low resolution. The PE of Equation 14 may represent the position embedding data coupled to the feature information. The Flatten of Equation 14 may represent an operation of converting multidimensional information into one-dimensional information. The Enc₁ of Equation 14 may represent an operation performed in the shallow CNN 523. The image restoration model according to an embodiment may consider a proximity between pixels in the image by using the position embedding data as an index representing an importance between the pixels in the image. Therefore, according to an embodiment, the image restoration model may be trained to use information (e.g., the PE, which is the position embedding data of Equation 14) indicating a spatial feature of the image to consider a distance between the pixels in the image while calculating the feature information.

In a state of processing the partial input image 205 using the image restoration model, the electronic device may perform a first operation of processing the partial input image 205 using the TPS model 521 and/or the shallow CNN 523 and a second operation of processing the partial input image 205 using a sub model 540 in parallel (or substantially simultaneously). The first operation and the second operation may be performed substantially simultaneously by different processors included in the electronic device. By using the sub model 540 in a state of being trained based on the operation described with reference to FIGS. 3 and 4, the electronic device may generate or obtain feature information DSTR(x′) from which bias is removed (or reduced) from the partial input image 205. In the sub model 540 according to an embodiment, a backbone 541, a transformer unit 543, a multi head cross attention model 545, a feed forward model 547, and a softmax 549 may be coupled in series. In an embodiment, the sub model 540 may also be referred to as a debiased scene-text recognizer (DSTR) in terms of generating the feature information DSTR(x′) from which the bias is removed (or reduced) from the partial input image 205.

The electronic device may obtain, or calculate, feature information Fₚ of Equation 15 from a projection model 551 by using the feature information DSTR(x′) obtained from the sub model 540.

$${F}_{p} = ( DSTR ( {x}^{′} ) + P E ) \cdot {W}_{p} \qquad [ Equation 15 ]$$

The Wₚ of Equation 15, which is an fc layer (or weights of the fc layer), may represent a layer defined for a projection operation and an operation of the layer. The PE of Equation 15 may represent the position embedding data coupled to the feature information.

By performing multi head cross attention 553 (or a softmax operation) and/or a layer normalization operation 555 on the feature information obtained from the projection model 551, the electronic device may obtain or calculate feature information

$${F}_{p}^{′}$$

### of Equation 16.

$${F}_{p}^{′} = LN ( softmax ( \frac{{Q}_{p} \cdot {K}_{p}^{T}}{\sqrt{d}} ) {V}_{p} + {F}_{p} ) \qquad [ Equation 16 ]$$

From the feature information Fₚ of Equation 15 and the feature information

$${F}_{p}^{′}$$

of Equation 16, the electronic device may obtain or calculate feature information

$${F}_{p}^{″}$$

of Equation 17 by performing a feed forward operation 557 and a layer normalization operation 559. In an embodiment, the feature information

$${F}_{p}^{″}$$

obtained through Equation 17 may be referred to as prior knowledge information 240.

$${F}_{p}^{″} = LN ( {F}_{p}^{′} \cdot {W}_{p}^{′} + {F}_{p} ) \qquad [ Equation 17 ]$$

Equation 17 may correspond to self-attention of the

$${F}_{p}^{′}$$

of Equation 16. For the self-attention, for example, Equation 17 may be defined to process the feature information

$${F}_{p}^{′}$$

of Equation 16 using a projection operation and a linearization operation (LN) based on the fc layer. An addition operation (e.g., a +F, operation and/or a

$$+ {F}_{p}^{′}$$

operation) of Equation 16 and Equation 17 may represent a residual connection (or identity mapping).

According to an embodiment, the electronic device may perform multi head cross attention between feature information Fᵥ of an encoder 220 and the prior knowledge information 240 of a recognizer 230 in a multi head cross attention model 250 of the image restoration model.

$${F}_{p}^{′′′}$$

of Equation 18 may represent feature information outputted from the multi head cross attention model 250.

$${F}_{p}^{′′′} = LN ( softmax ( \frac{{Q}_{v} \cdot {K}_{p}^{{″}^{T}}}{\sqrt{d}} ) {V}_{p}^{″} ) \qquad [ Equation 18 ]$$

A query for performing multi head cross attention of Equation 18 may correspond to feature information Fᵥ∈ [symbol] ^{c×hw} of the shallow CNN 523. The d of Equation 18 may represent a dimension of a key vector. The Qᵥ of Equation 18 is a projection (e.g., the projection based on the fc layer) of the Fᵥ of Equation 1, may represent a query vector. The

$${K}_{p}^{″}$$

and the

$${V}_{p}^{″} ,$$

which are projections (e.g., the projections based on the fc layer) of the

$${F}_{p}^{″}$$

of Equation 17 may represent a key vector and a value vector, respectively. The LN of Equation 18 may represent a linearization operation. The

$${Q}_{v} \cdot {K}_{p}^{{″}^{T}}$$

operation of Equation 18 may represent an attention score of the self-attention. The T operation of Equation 18 may represent a matrix transpose operation.

A key and A value for performing the multi head cross attention of Equation 18 may correspond to low-level feature information having a size of [symbol] ^{l×c} of the feature information of the recognizer 230. The [symbol] ^{l×c} may represent a feature dimension (the number) of the shallow CNN 523. The

$${Q}_{v} \cdot {K}_{p}^{{″}^{T}}$$

of Equation 18 may have a size of [symbol] ^{hw×l}, and the

$${Q}_{v} \cdot {K}_{p}^{{″}^{T}} \cdot {V}_{p}^{″}$$

of Equation 18 may have a size of [symbol] ^{hw×c}. Referring to Equation 18, the feature inform

$${F}_{p}^{′′′}$$

obtained using the softmax operation and the layer normalization (LN) operation may be obtained from the multi head cross attention model 250.

With respect to the feature information

$${F}_{p}^{′′′}$$

obtained from the multi head cross attention model 250, the electronic device may perform calculations represented by a serial connection of a merge model 571, a first layer normalization model 573, a feedforward model 575, and A second layer normalization model 577. Referring to FIG. 5, a residual connection for an element-wise sum may be formed between the first layer normalization model 573 and the second layer normalization model 577. The residual connection may be formed between the first layer normalization model 573 and the second layer normalization model 577, independently of the feed forward model 575.

Referring to FIG. 5, with respect to information obtained from the second layer normalization model 477, the electronic device may repeatedly perform calculations based on a BiLSTM model 585 N times (e.g., 5 times). A combination of a first convolution model 581, a second convolution model 583, and the BiLSTM model 585 connected to the second layer normalization model 577 may be referred to as a decoder 380. In an embodiment, feature information F that is obtained from the second layer normalization model 577, and is to be inputted to the decoder 380, may be represented as Equation 19.

$$F = LN ( LN ( {F}_{p}^{′′′} ) \cdot {W}_{f} + {F}_{p}^{′′′} ) \qquad [ Equation 19 ]$$

Equation 19 may be defined to process the feature information

$${F}_{p}^{′′′}$$

of Equation 18 using the projection operation and the linearization operation (LN) based on the fc layer. The W_{f} of Equation 19, which is the fc layer (or the weights of the fc layer), may represent the layer defined for the projection operation and the operation of the layer. The addition operation (e.g., the +F_p∧′ operation) of Equation 19 may represent the residual connection (or identity mapping).

The decoder 380 may have a sequential-recurrent block (SRB) in which the calculations represented by the BiLSTM model 585 are repeatedly performed N times (e.g., N=5). The electronic device may increase a resolution and/or a size of the image (e.g., the image represented by the feature information F of Equation 19) outputted by the decoder 380 by using a pixel shuffle model 587. For example, an output image 207 outputted from the pixel shuffle model 587 of the image restoration model may be determined based on Equation 20 and may correspond to a restored image, which is a result of Equation 20.

$$Restored Image = PixelSuffle ( SRB ( {F}_{v} , F ) ) \qquad [ Equation 20 ]$$

When training the image restoration model with the structure of FIG. 5 (e.g., the second step of the training process), a loss function to be used for training the image restoration model may represent a difference between a ground truth image corresponding to the partial input image 205 and the output image 207. For example, a L1 distance (e.g., a Manhattan distance and/or a rectangular street grid) between the ground truth image and the output image 207 may be determined as the loss function. An embodiment is not limited thereto, and a L2 distance (or a mean squared loss), a structural similarity index (SSIM), a triplex SSIM (TSSIM), and a Kullback-Leibler (KL) Divergence loss function for knowledge distillation may be used. For example, the loss function [symbol] ₛ based on the L2 distance may be defined as Equation 21.

$${ℒ}_{s} = {\vert {I}_{SR} - {I}_{HR} \vert}_{2} \qquad [ Equation 21 ]$$

The I_{SR} of Equation 21 may represent the output image 207, and the I_{HR} may represent the ground truth image. For training an image restoration model based on structural information of text, a loss function based on TSSIM may be used, for example, such as a loss function [symbol] ₜₛₛᵢₘ of Equation 22.

$${ℒ}_{tssim} = 1 - TSSIM \qquad [ Equation 22 ]$$

$$such that TSSIM = \frac{( {μ}_{x} {μ}_{y} + {μ}_{y} {μ}_{z} + {μ}_{x} {μ}_{z} + {C}_{1} ) ( {σ}_{xy} + {σ}_{yz} + {σ}_{xz} + {C}_{2} )}{( {μ}_{x}^{2} + {μ}_{y}^{2} + {μ}_{z}^{2} + {C}_{1} ) ( {σ}_{x}^{2} + {σ}_{x}^{2} + {σ}_{x}^{2} + {C}_{2} )}$$

The x of Equation 22 may correspond to the deteriorated output image 207, the y may correspond to the output image 207, and the z may correspond to the ground truth image. Each of μ and σ of Equation 22 is a mean and a standard deviation of corresponding images (e.g., the x, the y, and the z). The C of Equation 22 may be an epsilon value (e.g., which is a specified number set to prevent a zero division error, preferably C1=0.012, C2=0.032).

Hereinafter, an exemplary structure of an image restoration model connected to a teacher model will be described with reference to FIG. 6.

FIG. 6 illustrates an exemplary block diagram of a teacher model connected to a model for prior knowledge information included in an image restoration model executed by an electronic device according to an embodiment. The electronic device 101 and/or processor 110 of FIG. 1 may obtain, generate, and/or train the image restoration model described with reference to FIG. 6 by executing an image restoration program 125.

In an embodiment, the image restoration model may obtain a character recognition result (or feature information) t_{HR} from which bias is removed through a teacher model 620 receiving a high-resolution image 605. In an embodiment, the image restoration model may obtain the character recognition result (or the feature information) t_{HR} from which the bias is removed through Equation 23 below.

$${t}_{HR} = {DSTR}_{tea} ( {x}_{HR} ) \qquad [ Equation 23 ]$$

The DSTRₜₑₐ of Equation 23 may represent an operation for obtaining the character recognition result (or the feature information) t_{HR} form which the bias is removed from the high-resolution image x_{LR} by the teacher model 620.

In an embodiment, the image restoration model may obtain a character recognition result (or feature information) t_{LR} from which bias is removed through a sub model 540 receiving a partial input image 205. In an embodiment, the image restoration model may obtain the character recognition result (or feature information) t_{LR} from which the bias is removed through Equation 24 below.

$${t}_{LR} = {DSTR}_{stu} ( {x}_{LR} ) \qquad [ Equation 24 ]$$

The DSTRₛₜᵤ of Equation 24 may represent an operation for obtaining the character recognition result (or the feature information) t_{LR} form which the bias is removed from a low-resolution image x_LR by the sub model 540.

When training the sub model 540, the electronic device may use a loss function [symbol] _{distill}of Equation 25 to reduce a domain gap (e.g., a domain difference between the output image 207 with a high resolution and the partial input image 205 with a low resolution) of prior knowledge of the sub model 540.

$${ℒ}_{distill} = {\vert {t}_{HR} - {t}_{LR} \vert}_{1} + {D}_{KL} ( {t}_{LR} ‖ {t}_{HR} ) \qquad [ Equation 25 ]$$

The t_{HR} of Equation 25 may represent the character recognition result (or the feature information) t_{HR} obtained through Equation 23. The t_{LR} of Equation 25 may represent the character recognition result (or the feature information) t_{LR} obtained through Equation 24. The t_{HR} of Equation 25 may be generated from the fixed (or freezed) teacher model 620. The t_{LR} of Equation 25 may be generated from the trainable sub model 540. The loss function of Equation 25 may be determined by another method (e.g., the L1 distance). In an embodiment, the teacher model 620 and the sub model 540 may be models trained by the learning method described through FIGS. 3 and 4.

In an embodiment, the image restoration model may operate the final loss by summing losses. For example, the image restoration model may calculate the final loss [symbol] ₜₒₜₐₗ through Equation 26 below.

$${ℒ}_{total} = {ℒ}_{s} + {ℒ}_{tssim} + {ℒ}_{distill} \qquad [ Equation 26 ]$$

In Equation 26, the [symbol] ₛ may be operated through Equation 21. In Equation 26, the [symbol] ₜₛₛᵢₘ may be operated through Equation 22. In Equation 26, the [symbol] _{distill} may be operated through Equation 25.

According to an embodiment, the electronic device 101 may train the image restoration model based on the final loss [symbol] ₜₒₜₐₗ. For example, the electronic device 101 may update parameters (e.g., a projection model 550 and/or parameters of an encoder 220) of the image restoration model to reduce the final loss [symbol] ₜₒₜₐₗ.

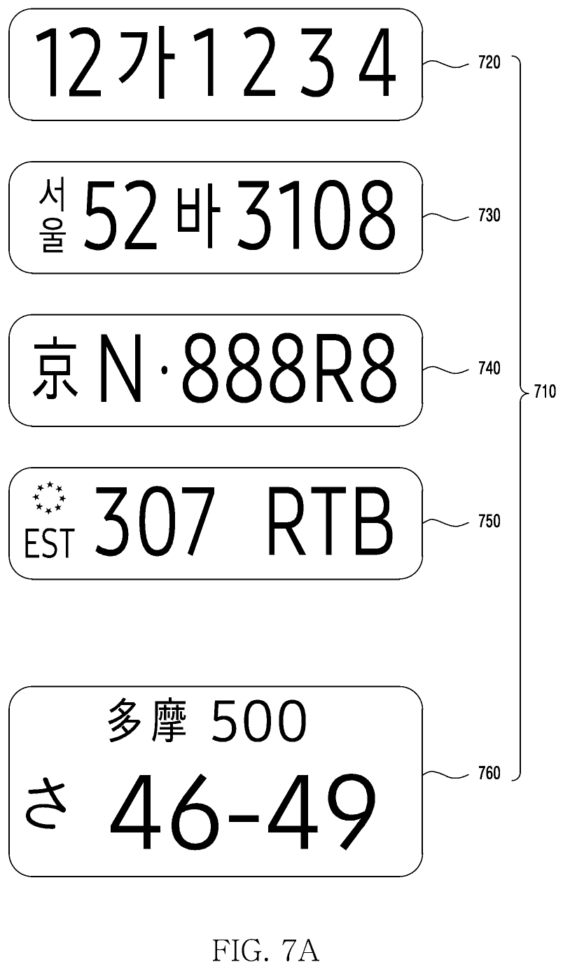

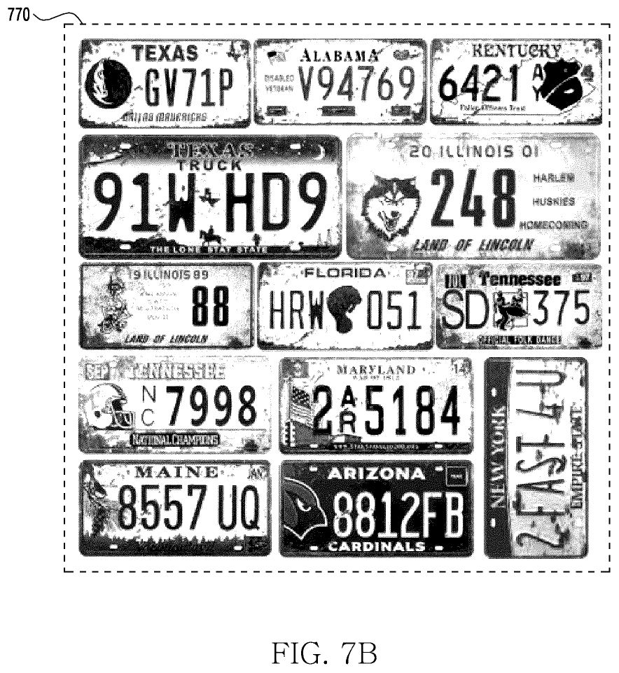

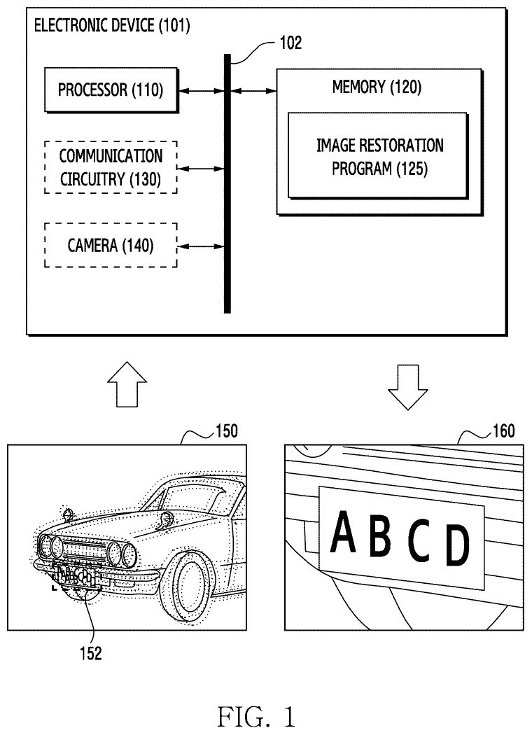

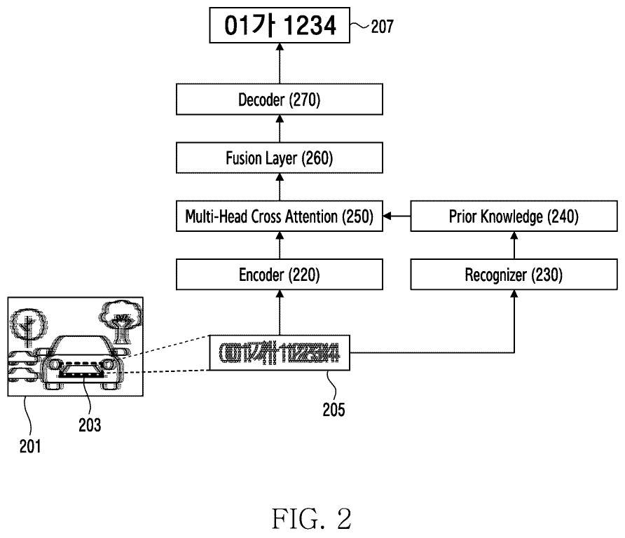

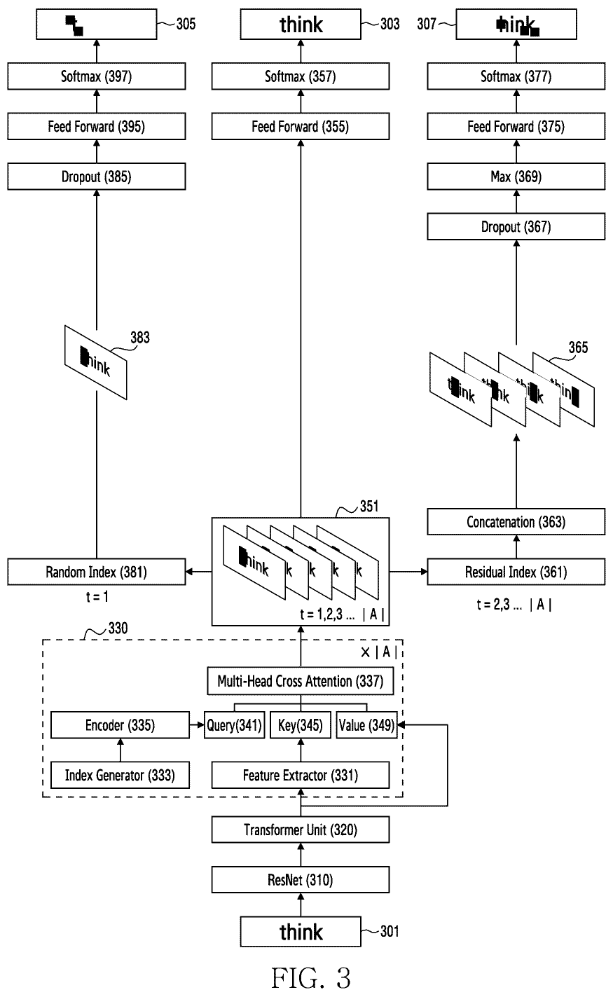

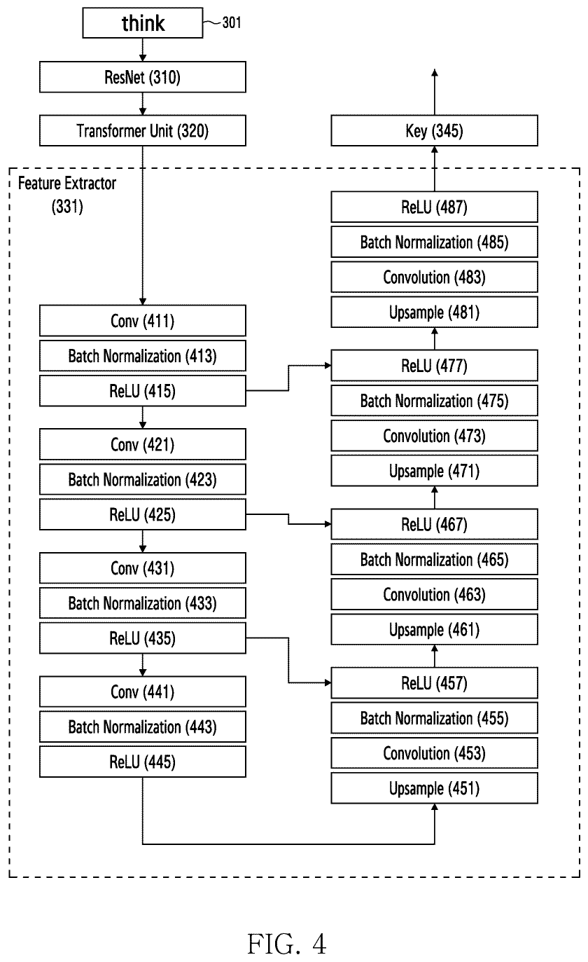

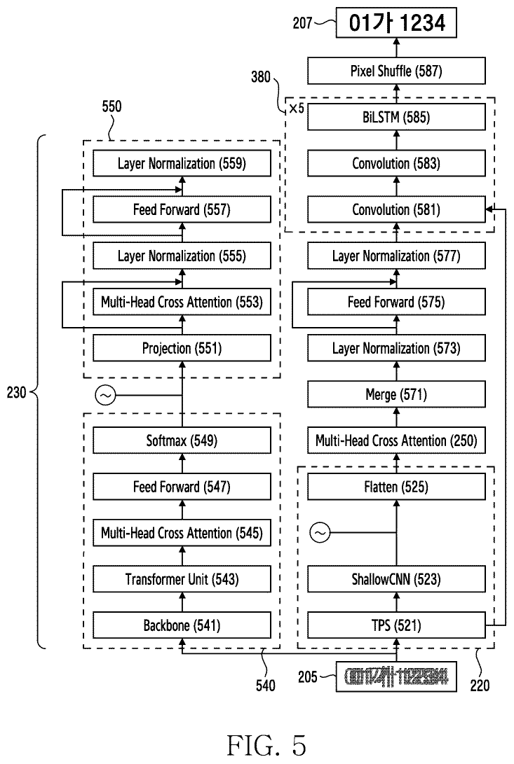

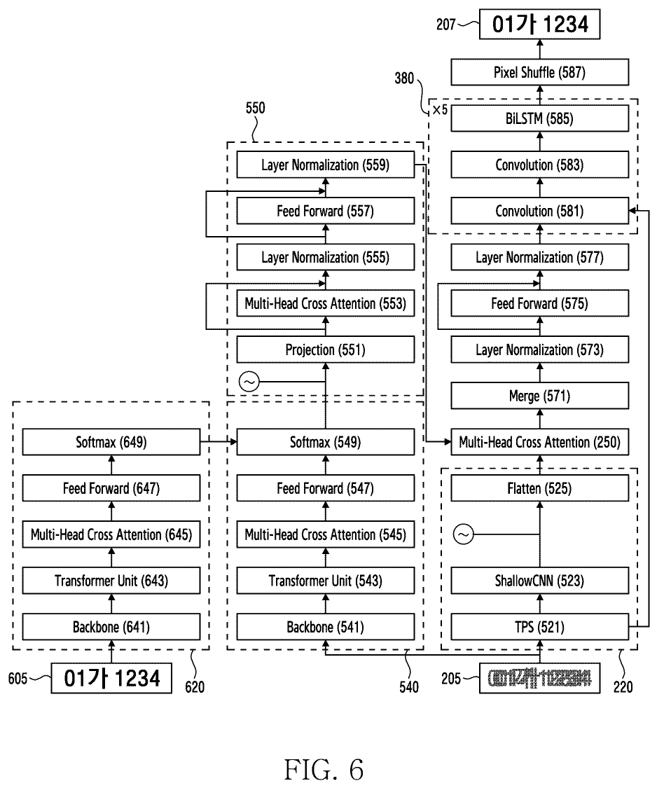

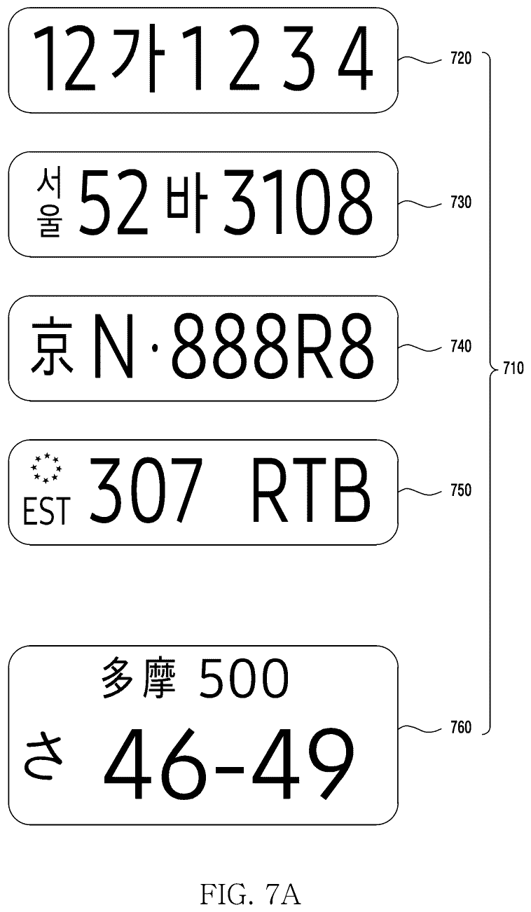

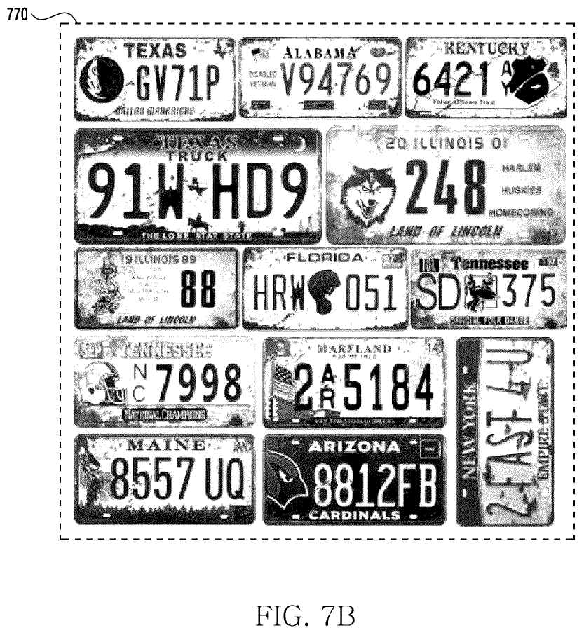

FIGS. 7A and 7B illustrate at least one number plate (or license plate), which is a subject included in an image restored by an image restoration model according to an embodiment.

Referring to FIG. 7A, images 710 including at least one number plate obtained from the image restoration model are illustrated. The images 710 may be outputted from, or provided by, an electronic device 101 that executes the image restoration model as a result of restoring or enhancing a low-resolution input image (e.g., the partial input image 205 of FIG. 2).

For example, the electronic device 101 may generate an image 720 including a number plate based on the law of the Republic of Korea. The image 720 may include numbers (e.g., 12), indicating a type of a vehicle, an alphabet (e.g., “ [symbol] ”) indicating a purpose of the vehicle, and numbers (e.g., 1234) indicating a serial number uniquely assigned to the vehicle. For example, the electronic device 101 may obtain an image 730 including a number plate based on the law of the Republic of Korea. The image 730 may further include, with respect to the image 720, characters (e.g., a place name such as “Seoul”) indicating an area associated with the number plate. A background color of the number plate represented through the images 720 and 730 may indicate a category (e.g., a private vehicle) of the vehicle defined by the law of the Republic of Korea.

For example, the electronic device 101 may generate an image 740 including a number plate based on the law of China. In the image 740, a character (e.g., [symbol] ) indicating an area associated with the number plate and a character (e.g., N) indicating a city (e.g., a sub-area of the area) associated with the number plate may include information on the area or use. The image 740 may include serial numbers (e.g., 888R8) uniquely assigned to a vehicle. A color of the number plate represented through the image 740 may indicate a category (e.g., a passenger car, a large vehicle, a bus, a truck, and/or a motorcycle) of the vehicle.

For example, the electronic device 101 may generate an image 750 including a number plate based on the law of the European Union. The image 750 may include a symbol indicating the European Union, characters (e.g., EST) indicating an area associated with the number plate, and serial numbers (e.g., “307 RTB”) uniquely assigned to a vehicle on which the number plate is mounted. An embodiment is not limited thereto, and the image 750 may further include a flag of a country in which the number plate is mounted as a country affiliated with the European Union.

For example, the electronic device 101 may generate an image 760 including a number plate based on the law of Japan. The image 760 may include characters (e.g., [symbol] ) indicating an area, numbers (e.g., 500) indicating a category of a vehicle, a character indicating a purpose of a business associated with the vehicle, and serial numbers (e.g., 46-49) uniquely assigned to the vehicle on which the number plate is mounted.

Referring to FIG. 7B, images 770 including a number plate based on the law of the United States generated by the electronic device 101 according to an embodiment are illustrated. Referring to the images 770, based on the law of the United States, the number plate including an image and/or a figure defined by a state government of the United States may be generated. The number plate may include text (e.g., “TEXAS”, “ALABAMA”, “KENTUCKY”, and the like) indicating a state government together with an image and/or a figure indicating the state government in which a vehicle is registered. Together with the text, the image representing the number plate may include a serial number (e.g., a combination of alphabets and/or the numbers such as “GV71P”) uniquely assigned to the vehicle.

In an embodiment, a method of increasing or enhancing a resolution of an image may be required to identify characters included in the image using a model trained to output feature information not biased to a semantic dependence relationship.

As described above, an electronic device may comprise memory storing instructions. The electronic device may comprise at least one processor configured to execute the instructions. The instructions, when executed by the at least one processor individually or collectively, may cause the electronic device to obtain an input image of a first resolution that includes one or more characters. The instructions, when executed by the at least one processor individually or collectively, may cause the electronic device to, using the input image, perform training of an image restoration model including a sub model trained to output a text probability map representing the one or more characters associated with the input image, an encoder configured to extract feature information from the input image, a fusion layer configured to combine the text probability map and the feature information, and a decoder connected to the fusion layer and for generating an output image with a second resolution higher than the first resolution. The sub model may be trained through one or more masked attention scores obtained by applying a specified masking ratio for a different single character selected among the one or more characters.

As described above, an electronic device 101 may increase or enhance a resolution of an image to identify characters included in the image using a model trained to output feature information not biased to a semantic dependence relationship.

The one or more masked attention scores may be obtained by applying the specified masking ratio to attention scores, the attention scores being obtained via a softmax between feature information of the input image and an embedding corresponding to the different single character selected from among the one or more characters.

The sub model may be trained by using loss functions based on text probability maps for each of the one or more characters, the text probability maps being obtained via the one or more masked attention scores. The loss functions may comprise a first loss function based on an entire text probability map, a second loss function based on a text probability map for the one character selected from among the one or more characters, and a third loss function based on text probability maps for remaining characters among the one or more characters.

The third loss function may be obtained based on a maximum text probability map configured with channel wise maximum values of the text probability maps associated with the third loss function.

The second loss function and the third loss function among the loss functions may be adjusted by a semantic dependency score based on the specified masking ratio.

The encoder may be trained using feature information generated by a teacher model, the teacher model being used to train the sub model using knowledge distillation.

The feature information generated by the teacher model may be obtained from one intermediate layer among intermediate layers included in the teacher model, the one intermediate layer being configured to generate feature information having the same size as the feature information of the encoder.

As described above, a method performed in an electronic device may comprise obtaining an input image of a first resolution that includes one or more characters. The method may comprise, using the input image, performing training of an image restoration model including a sub model trained to output a text probability map representing the one or more characters associated with the input image, an encoder configured to extract feature information from the input image, a fusion layer configured to combine the text probability map and the feature information, and a decoder connected to the fusion layer and for generating an output image with a second resolution higher than the first resolution. The sub model may be trained through one or more masked attention scores obtained by applying a specified masking ratio for a different single character selected among the one or more characters.

The one or more masked attention scores may be obtained by applying the specified masking ratio to attention scores, the attention scores being obtained via a softmax between feature information of the input image and an embedding corresponding to the different single character selected from among the one or more characters.

The sub model may be trained by using loss functions based on text probability maps for each of the one or more characters, the text probability maps being obtained via the one or more masked attention scores. The loss functions may comprise a first loss function based on an entire text probability map, a second loss function based on a text probability map for the one character selected from among the one or more characters, and a third loss function based on text probability maps for remaining characters among the one or more characters.

The third loss function may be obtained based on a maximum text probability map configured with channel wise maximum values of the text probability maps associated with the third loss function.

The second loss function and the third loss function among the loss functions may be adjusted by a semantic dependency score based on the specified masking ratio.

The encoder may be trained using feature information generated by a teacher model, the teacher model being used to train the sub model using knowledge distillation.

The feature information generated by the teacher model may be obtained from one intermediate layer among intermediate layers included in the teacher model, the one intermediate layer being configured to generate feature information having the same size as the feature information of the encoder.

As described above, in a non-transitory computer readable storage medium comprising instructions, the instructions may be configured, when executed by at least one processor of an electronic device individually or collectively, to cause the electronic device to obtain an input image of a first resolution that includes one or more characters. The instructions may be configured, when executed by the at least one processor individually or collectively, to cause the electronic device to, using the input image, perform training of an image restoration model including a sub model trained to output a text probability map representing the one or more characters associated with the input image, an encoder configured to extract feature information from the input image, a fusion layer configured to combine the text probability map and the feature information, and a decoder connected to the fusion layer and for generating an output image with a second resolution higher than the first resolution. The sub model may be trained through one or more masked attention scores obtained by applying a specified masking ratio for a different single character selected among the one or more characters.

The one or more masked attention scores may be obtained by applying the specified masking ratio to attention scores, the attention scores being obtained via a softmax between feature information of the input image and an embedding corresponding to the different single character selected from among the one or more characters.

The sub model may be trained by using loss functions based on text probability maps for each of the one or more characters, the text probability maps being obtained via the one or more masked attention scores. The loss functions may comprise a first loss function based on an entire text probability map, a second loss function based on a text probability map for the one character selected from among the one or more characters, and a third loss function based on text probability maps for remaining characters among the one or more characters.

The third loss function may be obtained based on a maximum text probability map configured with channel wise maximum values of the text probability maps associated with the third loss function.

The second loss function and the third loss function among the loss functions may be adjusted by a semantic dependency score based on the specified masking ratio.

As described above, a method performed in an electronic device may comprise receiving a request for restoring an input image of a first resolution to an output image of a second resolution exceeding the first resolution. The method may comprise, based on the received request, executing an image restoration model including an encoder configured to extract feature information from the input image, a sub model to determine a text probability map for the input image, a fusion layer configured to combine the text probability map and the feature information, and a decoder connected to the fusion layer and for generating the output image of the second resolution. The method may comprise providing the output image of the second resolution, obtained based on the execution of the image restoration model, as a response to the request. The sub model may be trained through one or more masked attention scores obtained by applying a specified masking ratio for a different single character selected among the one or more characters.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

1. An electronic device comprising:
memory storing instructions; and
at least one processor configured to execute the instructions,
wherein the instructions, when executed by the at least one processor individually or collectively, cause the electronic device to:
obtain an input image of a first resolution that includes one or more characters; and
using the input image, perform training of an image restoration model including:
a sub model trained to output a text probability map representing the one or more characters associated with the input image;
an encoder configured to extract feature information from the input image;
a fusion layer configured to combine the text probability map and the feature information; and
a decoder connected to the fusion layer and for generating an output image with a second resolution higher than the first resolution,
wherein the sub model is trained through one or more masked attention scores obtained by applying a specified masking ratio for a different single character selected among the one or more characters.

2. The electronic device of claim 1,
wherein the one or more masked attention scores are obtained by applying the specified masking ratio to attention scores, the attention scores being obtained via a softmax between feature information of the input image and an embedding corresponding to the different single character selected from among the one or more characters.

3. The electronic device of claim 1,
wherein the sub model is trained by using loss functions based on text probability maps for each of the one or more characters, the text probability maps being obtained via the one or more masked attention scores; and
wherein the loss functions comprise:
a first loss function based on an entire text probability map,
a second loss function based on a text probability map for the one character selected from among the one or more characters, and
a third loss function based on text probability maps for remaining characters among the one or more characters.

4. The electronic device of claim 3,
wherein the third loss function is obtained based on a maximum text probability map configured with channel wise maximum values of the text probability maps associated with the third loss function.

5. The electronic device of claim 3,
wherein the second loss function and the third loss function among the loss functions are adjusted by a semantic dependency score based on the specified masking ratio.

6. The electronic device of claim 1,
wherein the encoder is trained using feature information generated by a teacher model, the teacher model being used to train the sub model using knowledge distillation.

7. The electronic device of claim 6,
wherein the feature information generated by the teacher model is obtained from one intermediate layer among intermediate layers included in the teacher model, the one intermediate layer being configured to generate feature information having the same size as the feature information of the encoder.

8. A method performed in an electronic device, comprising:
obtaining an input image of a first resolution that includes one or more characters; and
using the input image, performing training of an image restoration model including:
a sub model trained to output a text probability map representing the one or more characters associated with the input image;
an encoder configured to extract feature information from the input image;
a fusion layer configured to combine the text probability map and the feature information; and
a decoder connected to the fusion layer and for generating an output image with a second resolution higher than the first resolution, and
wherein the sub model is trained through one or more masked attention scores obtained by applying a specified masking ratio for a different single character selected among the one or more characters.

9. The method of claim 8,
wherein the one or more masked attention scores are obtained by applying the specified masking ratio to attention scores, the attention scores being obtained via a softmax between feature information of the input image and an embedding corresponding to the different single character selected from among the one or more characters.

10. The method of claim 8,
wherein the sub model is trained by using loss functions based on text probability maps for each of the one or more characters, the text probability maps being obtained via the one or more masked attention scores; and
wherein the loss functions comprise:
a first loss function based on an entire text probability map,
a second loss function based on a text probability map for the one character selected from among the one or more characters, and
a third loss function based on text probability maps for remaining characters among the one or more characters.

11. The method of claim 10,
wherein the third loss function is obtained based on a maximum text probability map including channel wise maximum values of the text probability maps associated with the third loss function.

12. The method of claim 10,
wherein the second loss function and the third loss function among the loss functions are adjusted by a semantic dependency score based on the specified masking ratio.

13. The method of claim 8,
wherein the encoder is trained using feature information generated by a teacher model, the teacher model being used to train the sub model using knowledge distillation.

14. The method of claim 13,
wherein the feature information generated by the teacher model is obtained from one intermediate layer among intermediate layers included in the teacher model, the one intermediate layer being configured to generate feature information having the same size as the feature information of the encoder.

15. A non-transitory computer readable storage medium, comprising instructions,
wherein the instructions are configured, when executed by at least one processor of an electronic device individually or collectively, to cause the electronic device to:
obtain an input image of a first resolution that includes one or more characters; and
using the input image, perform training of an image restoration model including:
a sub model trained to output a text probability map representing the one or more characters associated with the input image;
an encoder configured to extract feature information from the input image;
a fusion layer configured to combine the text probability map and the feature information; and
a decoder connected to the fusion layer and for generating an output image with a second resolution higher than the first resolution, and
wherein the sub model is trained through one or more masked attention scores obtained by applying a specified masking ratio for a different single character selected among the one or more characters.

16. The non-transitory computer readable storage medium of claim 15,
wherein the one or more masked attention scores are obtained by applying the specified masking ratio to attention scores, the attention scores being obtained via a softmax between feature information of the input image and an embedding corresponding to the different single character selected from among the one or more characters.

17. The non-transitory computer readable storage medium of claim 16,
wherein the sub model is trained by using loss functions based on text probability maps for each of the one or more characters, the text probability maps being obtained via the one or more masked attention scores; and
wherein the loss functions comprise:
a first loss function based on an entire text probability map,
a second loss function based on a text probability map for the one character selected from among the one or more characters, and
a third loss function based on text probability maps for remaining characters among the one or more characters.

18. The non-transitory computer readable storage medium of claim 17,
wherein the third loss function is obtained based on a maximum text probability map including channel wise maximum values of the text probability maps associated with the third loss function.

19. The non-transitory computer readable storage medium of claim 17,
wherein the second loss function and the third loss function among the loss functions are adjusted by a semantic dependency score based on the specified masking ratio.

20. The non-transitory computer readable storage medium of claim 15,
wherein the encoder is trained using feature information generated by a teacher model, the teacher model being used to train the sub model by knowledge distillation.
